(19) United States
(12) Patent Application Publication
(10) Pub. No.: US 2009/0158266 A1
(43) Pub. Date: Jun. 18, 2009

(54) DEPLOYMENT TOOL FOR INCREASING EFFICIENCY IN A PRODUCTION COMPUTER SYSTEM

(75) Inventors: Massimiliano Celli, Latina (IT); Luigi Pichetti, Rome (IT); Marco Secchi, Rome (IT); Marcello Velati, Rome (IT)

Correspondence Address: IBM CORP. (AUSTIN), C/O NELSON AND NELSON, 2984 E. EVERGREEN AVE., SALT LAKE CITY, UT, 84109, US

(73) Assignee: International Business Machines Corporation, Armonk, NY (US)

(21) Appl. No.: 12/201,227

(22) Filed: Aug. 29, 2008

(30) Foreign Application Priority Data
Dec. 12, 2007 (EP) EP07123042

(51) Int. Cl. G06F 9/445

(52) U.S. Cl. 717/168

(57) ABSTRACT

A method is presented for deploying a component onto a production computer system. The method may include identifying one or more alterations associated with deployment of a first application onto a first computer system, where the first application on the first computer system is substantially similar to a second application on a second computer system. Embodiments may further include generating a command and an object corresponding to the alteration, where the command and the object are generated as a function of the first application. The alteration may then be replicated on the second application of the second computer system by executing the command and the object on the second computer system.

### BACKGROUND OF THE INVENTION

Computers are increasingly fundamentally important for business performance and management. Reliable computer systems, particularly those critical to production and business operations, are therefore essential, as computer down-time can be catastrophic in terms of lost sales and business opportunities.

Strict processes, such as regression testing, are often implemented to ensure quality and robustness in production computer systems. In particular, when a component needs to be updated on the production system because of a new functionality or to fix a bug, the change may be developed and tested in isolation before it is loaded onto the production system. Its integration in a broader context may then be tested, particularly to check that the new component does not interfere with normal system execution processes.

Once a change is tested in the test environment, the change may be deployed in a quality assurance (“QA”) environment prior to deployment in the production environment. In addition to functional and performance tests, the deployment procedure itself may be carefully fine-tuned in the QA environment to minimize problems when the change is installed in the production environment.

### SUMMARY OF THE INVENTION

Embodiments of the invention have been developed to provide improved tools for deploying a component onto a production computer system.

Some embodiments of the present invention include identifying one or more alterations associated with deployment of a first application onto a first computer system. The first application on the first computer system may be substantially similar to a second application on a second computer system. Embodiments may further include generating a command and an object corresponding to the alteration, where the command and the object are generated as a function of the first application. The alteration may then be replicated on the second application of the second computer system by executing the command and the object on the second computer system.

A corresponding apparatus and computer program product for implementing the above-stated method are also disclosed and claimed herein.

### BRIEF DESCRIPTION OF THE DRAWINGS

In order that the disclosure will be readily understood, a more particular description of embodiments of the invention briefly described above will be rendered by reference to specific embodiments illustrated in the appended drawings. Understanding that these drawings depict only typical embodiments of the invention and are not therefore to be considered limiting of its scope, embodiments of the invention will be described and explained with additional specificity and detail through use of the accompanying drawings, in which:

FIG. 1 shows a typical system environment in which the present invention may be implemented;

FIG. 2 shows a high-level process with steps for updating a production system according to the current state of the art;

FIG. 3 shows an overview of one embodiment of a system implementing the present invention;

FIG. 4 shows details of an application plugin in one embodiment of the present invention;

FIG. 5 shows a high-level process with steps for updating a production system in one embodiment of the present invention; and

FIG. 6 shows a high-level process with steps for executing changes onto a production system in one embodiment of the present invention.

### DETAILED DESCRIPTION OF THE INVENTION

It will be readily understood that the components of embodiments of the present invention, as generally described and illustrated in the Figures herein, may be arranged and designed in a wide variety of different configurations. Thus, the following more detailed description of the embodiments of the systems and methods of the present invention, as represented in the Figures, is not intended to limit the scope of the disclosure, as claimed, but is merely representative of selected embodiments of the invention.

Reference throughout this specification to “one embodiment,” “an embodiment,” or similar language means that a particular feature, structure, or characteristic described in connection with the embodiment may be included in at least one embodiment of the present invention. Thus, appearances of the phrases “in one embodiment” or “in an embodiment” in various places throughout this specification are not necessarily all referring to the same embodiment.

Furthermore, the described features, structures, or characteristics may be combined in any suitable manner in one or more embodiments. One skilled in the relevant art will recognize, however, that embodiments of the invention can be practiced without one or more of the specific details, or with other methods, components, etc. In other instances, well-known structures, or operations are not shown or described in detail to avoid obscuring aspects of the disclosure.

The illustrated embodiments of the invention will be best understood by reference to the drawings, wherein like parts are designated by like numerals throughout. The following description is intended only by way of example, and simply illustrates certain selected embodiments of the invention that are consistent with the disclosure as claimed herein.

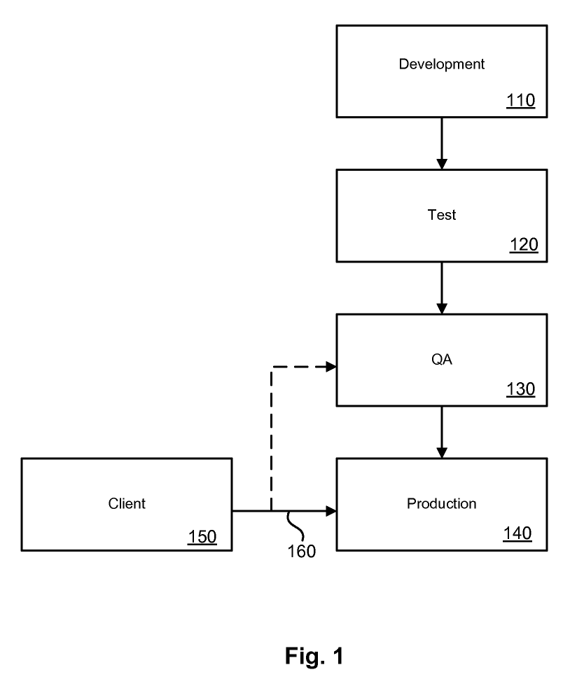

FIG. 1 shows a typical system environment in which the present invention may be implemented. The system may include a development system 110, in which a new component may be developed; a test system 120, in which a new component may be functionally tested; a quality assurance system 130, in which the integration of a new component into the existing environment may be tested and verified; a production system 140, the main system in which the component may be executed; and a client environment 150. The client environment 150 may be used by end users to perform tasks while accessing the production system 140 via requests on a network connection 160. Each system may represent a phase of the deployment process for a new component. Deployment of a component from one phase to the next may be performed across a network to facilitate copy of code.

Embodiments of the present invention aim to minimize error when a component is deployed onto the production system 140. To this end, the quality assurance (“QA”) system 130 may be very similar to the production system 140. Particularly, the QA system 130 may have the same applications installed as the production system 140, and the environment may be so set that the state of the applications is also maintained very close to the state of the applications in the production system 140. A common mechanism to ensure such similarity of the applications state is to forward to the QA system 130 every request 160 that the production system 140 receives from a client 150. In this manner, the impact of a new component on the production system 140 may be accurately assessed based on the impact of the new component on the quality assurance system 130. In particular, a component that does not impede the working of the QA system 130 may also not impede the working of the production system 140.

A new component may be first developed in a development environment 110. This component can implement new functionality in response to a new need, or may fix a bug identified while using the production system 140. The component may be a simple library or a more complex application. Once developed, the new component may be first tested in isolation in the development environment 110 to make sure that the required functionality is correctly implemented.

The component may be migrated to the test system 120 to test the integration of the new component in a broader system. In this environment, the new component may be tested to determine whether the component hinders the functionality of other components with which it interacts. The new component may also be tested to determine whether it is able to react properly to environmental inputs, and particularly to determine whether it is able to handle errors in a suitable manner to avoid unexpected situations. The new component may be tested in various situations to stress the new component prior to implementation in the production system 140.

The component may then be deployed in the QA system 130 which, as mentioned above, may substantially mimic the behavior of the production system 140 to determine the likely impact of the new component on the production system 140. In complex environments where interactions between the components are numerous and difficult to anticipate, this step may be particularly helpful.

Further, in some cases, deployment of the component itself may be difficult, requiring a carefully designed process to make sure that nothing is broken during installation. Also, installation of the new component in complex environments may be difficult to standardize as it may require setting various environment-dependent parameters. Hence, the installation process may be both risky and error-prone. The QA system 130 may relieve at least some of these risks, as it may receive substantially similar requests as the production system 140. Accordingly, the QA system 130 may offer the opportunity to test the impact of the new component on system 140 performance.

After successful installation on the QA system 130, the component may be deployed onto the production system 140. The installation process may be similar to the installation process for the QA system 130, although machine-dependent settings may need to be adjusted. Installation may be performed by experienced system administrators, as the consequences of improper installation can be catastrophic to the system. Further, the root cause of a problem may be difficult to analyze and fix, especially in modern complex systems. This difficulty may arise from interacting applications obtained from different vendors, and from the large amount of fine tuning needed to satisfy environmental requirements.

In some embodiments, each of the main component systems may comprise several machines. For instance, the number of computer machines in the production system 140 may be very high, as the production system 140 may handle a great number of requests simultaneously. In this case, the machines may be similar, and a work load balancer may be used to intercept a request to the production system 140 and forward it to a less loaded machine. The number of machines in the QA system 130 and production system 140 may very be different.

In some embodiments, fewer steps may be involved to deploy a new component from the development system 110 to the production system 140. For instance, the test system 120 and the QA system 130 may be merged to avoid duplication of hardware and reduce costs.

The component to be deployed may include a software library in the form of a binary, a configuration file in ASCII format, or a combination of both. The deployment may also comprise a large number of components. The deployment process may be used for the installation of a new component, for the update of an already-installed component, or for the configuration or fine tuning of an existing component.

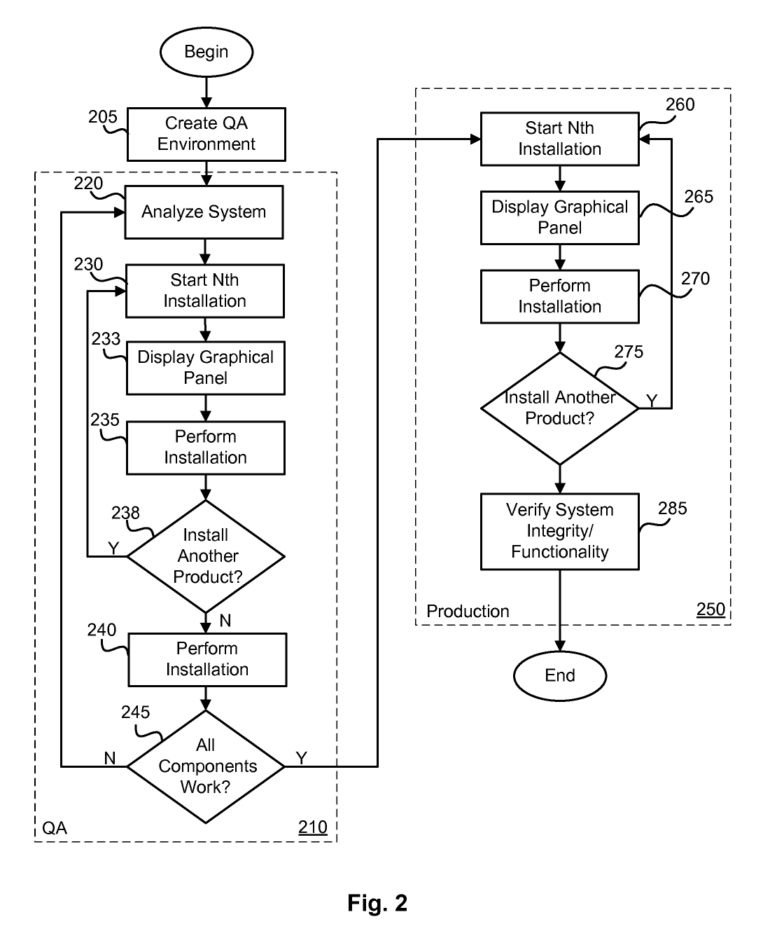

Referring now to FIG. 2, a process for updating a production system in accordance with certain embodiments of the present invention may include a first step 205 for creating a QA system 130 that is substantially similar to a production system 140. Subsequent steps may be divided into steps 210 corresponding to tasks executed on the QA system 130, and steps 250 corresponding to tasks executed on the production system 140.

Steps 210 corresponding to tasks executed on the QA system 130 may include, for example, analyzing 220 the system, starting 230 the installation or configuration process of a component in the QA system 130, displaying 233 a graphical panel if the installation or configuration of the component requires user interaction, and performing 235 the installation or configuration. A decision 238 may then be made regarding a need to install another component or product. The graphical panel step 233 may be omitted where installation of a particular component may be executed without user interaction.

Once all the components have been installed or configured, the integrity of the system and its functionalities may be checked 240. Verification 240 of system integrity may include standard software testing techniques such as regression tests, unit tests, and other such tests known to those in the art. If all the components of the system work as expected 245, the method may proceed to steps 250 corresponding to tasks performed on the production system 140. Else, the process may be re-executed from the analyzing step 220 to fine tune the installation process.

Steps 250 corresponding to tasks executed on the production system 140 may include starting 260 the installation or configuration process of a component in the production environment, displaying 265 a graphical panel if the installation or configuration of the component requires user interaction, and performing 270 the installation or configuration. A decision 275 may then be made regarding the need to install another component or product. As in the previous set of steps 210 performed on the QA system 130, the graphical panel step 265 may be omitted where installation of a particular component may be executed without user interaction.

Once all the components have been installed or configured, the integrity of the system and its functionalities may be checked 285. Verification 285 of system integrity may include standard software testing techniques such as regression tests, unit tests, and other such tests known to those in the art. The component may then be deployed in the production system 140. If a problem occurs in the production system 140 that did not occur in the QA system 130, the QA system 130 may not correctly represent the production system 140, and corrective actions as known by those in the art may need to be taken.

Installation steps 210 in the QA system 130 are designed to ensure that the installation process will be successful when performed on the production system 140. Because installation or configuration can be very complex in systems where many components interact together, the system administrator performing the installation may carefully document each step performed on the QA system 130 to enable performance of substantially similar steps on the production system with minimal risk of error. In some embodiments, the system administrator may deviate from the standard installation process of a particular component to take into account some system specificities. Such deviation may be registered during the QA phase 210 for reproduction during the production phase 250.

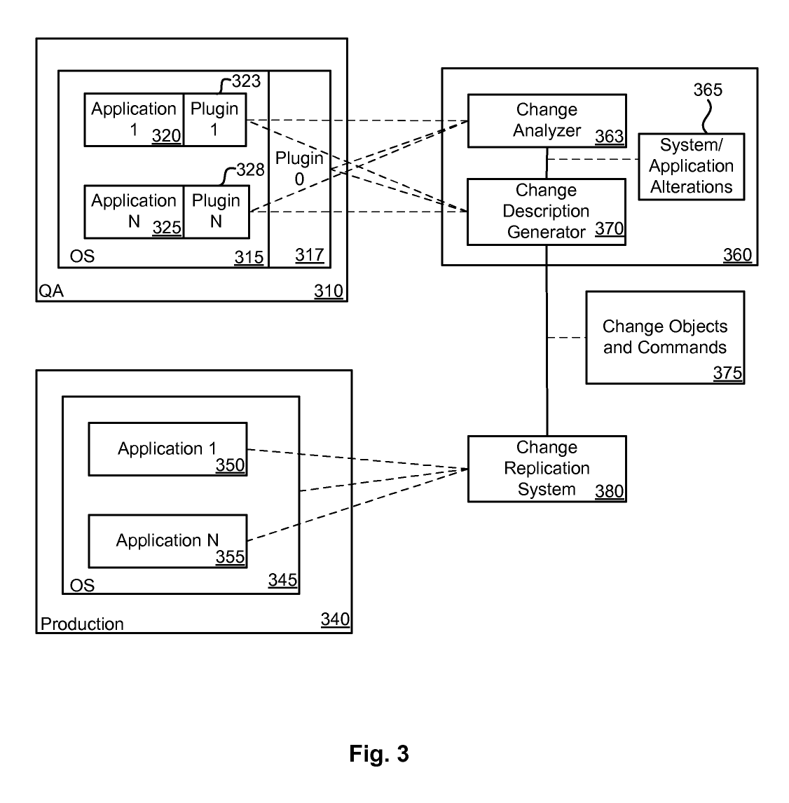

Referring now to FIG. 3, a system implementing embodiments of the present invention may include an environment 310 for hosting the QA system 130, an environment 340 for hosting the production system 140, a change monitoring system 360, and a change replication system 380.

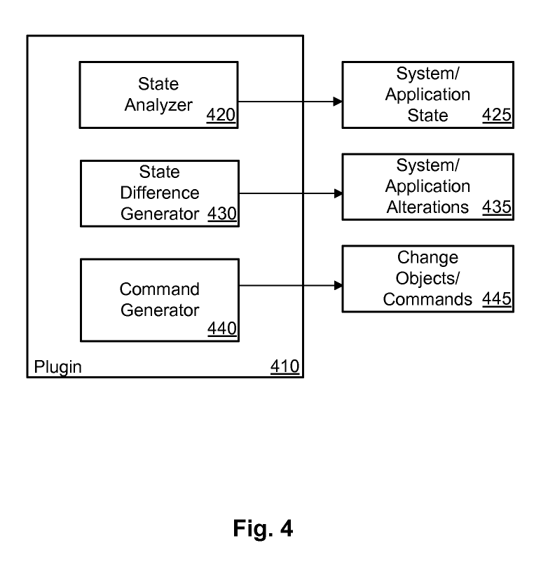

In one embodiment, the QA environment 310 includes an operating system 315, a first application 320, and an Nth application 325. The operating system 315 or any of the applications may be further accessed through the use of a plugin 317, 323, 328 which will be further described with respect to FIG. 4 below.

In certain embodiments, the production environment 340 may include an operating system 340, a first application 350, and an Nth application 355. The change monitoring system 360 may include a change analyzer 363 and a change description generator 370. The change analyzer 363 and the change description generator 370 may interact with the applications 320, 325 or the operating system 315 via plugins 323, 328, 317. The change description generator 370 may receive as input a list of operating system or application alterations 365 from the change analyzer 363.

In some embodiments, the change replication system 380 may receive as input from the change monitoring system 360 a set of commands and object changes 375. The change replication system 380 may interact directly with the applications 350, 355 or the operating system 345 of the production environment 340.

In some embodiments, the applications 320, 325 in the QA system 310 may be substantially similar to the production system 340, with similar version numbers or build numbers. In this manner, the QA system 310 may facilitate anticipating the impact of deploying a new component in the production system 340 based on QA system 310 performance after deployment of the component.

The change analyzer 363 may generate a list of alterations 365 resulting from the deployment of a new component in the QA system 310. In one embodiment, this list of alterations 365 for a particular application 320, 325 or operating system 310 may be obtained from the plugin associated with the respective application 323, 328 or operating system 317. The application-specific plugin may be configured to take into account the specificities of the application, thus generating a better representation of the alterations. The change analyzer 363 may then provide to the change description generator 370 the list of alterations 365 that occurred on the system during deployment of the new component. This list of alterations 365 may be transformed from the plugin format to a pivot format to make them more generic.

The change description generator 370 may generate, based on the list of alterations 365, a set of commands and change objects 375 which may be transmitted to the change replication system 380. The change replication system 380 may replicate the changes from the QA system 310 to the production system 340. The commands and objects 375 may also be generated by relying on the application-specific plugins 317, 323, 328 to more synthetically and accurately describe the alterations. Plugins will be described in more detail with respect to FIG. 4 below.

The change replication system 380 may receive as input the set of change objects and commands 375. It may then use, for instance, the various application programming interfaces (“API”) to update the production system 340 so as to bring it to a state substantially similar to the QA system 310. In some embodiments, various changes may be propagated to the production system 340, as discussed in more detail with respect to FIG. 4.

In some embodiments, the plugins 317, 328, 323 of the QA system 310 may be reused to ensure optimal deployment of the changes in the production system 340. As the plugins may be specifically developed for a particular application, they may be tailored to implement a change while taking into account the application specificities. In such a case, the set of change objects and commands may be left in a format adapted to each application (for instance SQL for a SQL database, or a JACL file for a J2EE application server).

FIG. 4 illustrates one embodiment of an application plugin in accordance with the present invention. An application plugin may include a plugin framework 410, a state analyzer 420 giving as output the application or system state 425, a state difference generator 430 giving as output the application or system alterations 435, and a command generator 440 giving as output a set of change objects and commands 445.

An application plugin may include a library providing a high-level API to a particular application. Instead of accessing the application directly, the plugin may be used to analyze application state and detect changes in the application, or in the data or business processes managed by the application, that have resulted from the installation process. To access this information, the plugin may take into account particularities of the application and/or operating system.

The state analyzer 420 may give a snapshot of the state of a particular application. For instance, in the case of a J2EE application server, the state analyzer 420 may issue the JACL command “$AdminApp list” to get the list of applications installed on the application. A typical output might be, for instance, “Application 1, Application 2”, or any representation with a markup language, such as XML. The state analyzer 420 may be requested again to provide the state 425 of the application after an update or configuration of the application. Table 1 shows an example of change analysis output for a J2EE Application Server. Table 2 shows an example of change analysis output for SQL Database.

TABLE 1
Example of change analysis output for a J2EE Application Server

```
Input Jacl file:
      $AdminApp list
    Output 1° snapshot
            Application1
            Application2
      Output 2° snapshot:
            Application1
            Application3
            Application4
        Differencing engine:
            <need to “find” the .ear for each installed application>
      Output Jacl file:
            $AdminApp uninstall Application2
            $AdminApp install <ear> -appname
Application3
            $AdminApp install <ear> -appname
Application4
            $AdminConfig save
```

TABLE 2
Example of change analysis output for SQL Database

```
Input sql file:
        list tables
    Output 1° snapshot:
        table1
        table2
    Output 2° snapshot:
        table1
        table3
        table4
    Differencing engine:
        <need to “find” the description for each added table>
    Output sql file:
        drop table table2
        create table table3 <description>
        create table table4 <description>
        commit
```

The state difference generator 430 may perform an analysis of the difference between the two generated states and generate a description of the application alterations 435. These alterations can be described in a generic form using simple operations such as create, retrieve, update or delete on contained elements such as objects, methods, attributes, etc. Based on the found alterations, the command generator 440 may generate a set of commands associated with a set of change objects 445. These commands and change objects 445 may be used to replicate the alterations directly by using the API of the corresponding application.

In one embodiment, the change analyzer 363 may send a request to the state analyzer 420 of a plugin 410 to get the state of a particular application. The change analyzer 363 may also send a request to the state difference generator 430. The request may input at least two different states of an application to get the alterations of a particular application 435. The change description generator 370 may then send a request to the command generator 440 of a plugin 410 to get the set of commands associated with the change objects 445.

The aggregation by the change analyzer 363 of the alteration descriptions generated by the various plugins may generally correspond to the application alterations element 365 of FIG. 3. Further, the aggregation by the change description generator 370 of the object changes and commands generated by the various plugins may generally correspond to the set of object changes and commands element 375 of FIG. 3.

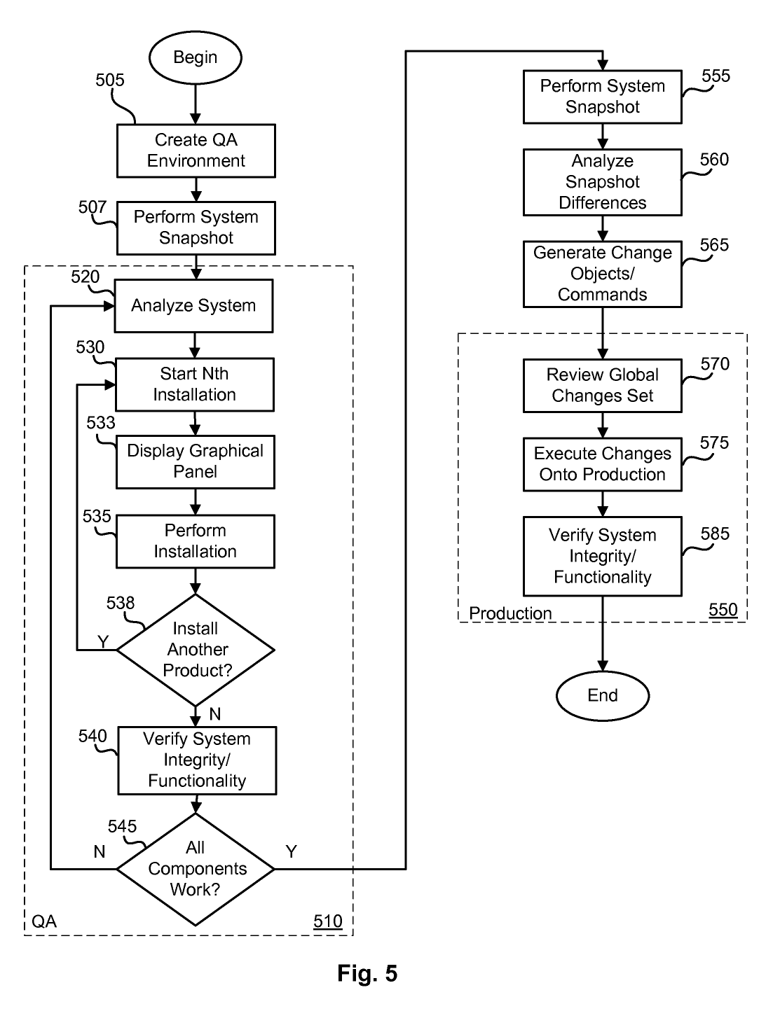

FIG. 5 shows a high-level process with the main steps for updating a production system in accordance with one embodiment of the present invention. As shown, the method may include creating 505 the QA environment from the production environment, performing 507 a first system snapshot, and performing a set of steps 510 for installing or configuring a new component on the QA system. The set of steps 510 may include analyzing 520 the QA system, starting 530 the installation or configuration of a new component, displaying 533 a graphical panel to assist the system administrator in the deployment of the new component, if needed, and performing 535 the installation or configuration. The set of steps 510 may include a decision step 538 for determining whether another component or product must be installed. The set of steps 510 may further include verifying 540 the system integrity and functionalities, and checking 545 whether all the components work as expected.

At this point, a second system snapshot may be taken 555. Differences between the snapshots may be analyzed 560, and change objects and commands may be generated 565.

A set of steps 550 may then be executed in the production system. These steps 550 may include reviewing 570 the generated set of global changes, executing 575 the changes, and verifying 585 the system's integrity and functionalities.

In certain embodiments, the system snapshots performed at steps 507 and 555 may be performed using the state analyzer 420 of the applications' plugins, described above with respect to FIG. 4. Analysis 560 of the differences between snapshots may be performed by the plugins' state difference generator 430, as described with above with respect to FIG. 4, upon request from the change analyzer 363. The differences may be in the data of the application, in the configuration of the application, or in any other part or feature of the application known to those in the art.

In certain embodiments, change objects and commands 565 may be generated by the change description generator 370, described above with respect to FIG. 3, and may interface with the command generator 440 of the various plugins, described above with respect to FIG. 4. Further, in some embodiments, the generated set of global changes may be reviewed 570 and executed 575 by the change replication system 380, described above with respect to FIG. 3.

In this manner, certain embodiments of the invention enable component installation or configuration to be performed only once (on the QA system only), rendering deployment of the new component in the production system faster and less error-prone, thereby reducing system down-time. Further, in some embodiments, this method may be used to reconfigure or fine-tune a particular application in a QA system, and to quickly and easily deploy the reconfiguration in a production system.

In certain embodiments, the change analyzer 363 may monitor the state of one or several applications. This capability individuates and associates to the software a set of areas, such as file system, registry entries, DB fields, or the like, where the software is expected to write. In this way profiles may be created to facilitate future upgrades of a particular application.

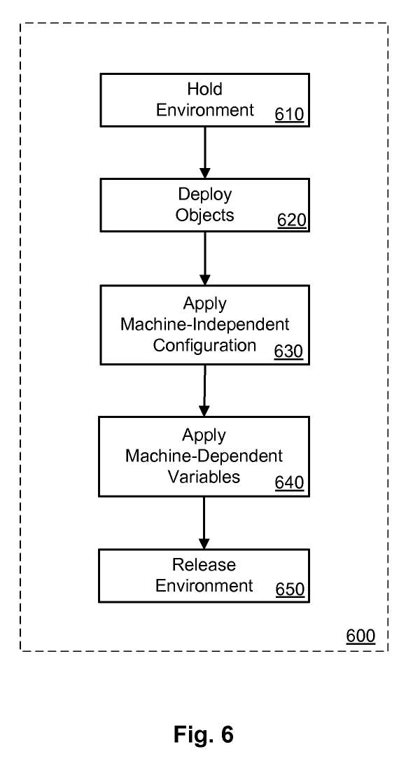

Referring now to FIG. 6, steps for executing 575 changes onto a production system in one embodiment of the present invention may include holding 610 the environment, deploying 620 the objects, applying 630 the machine-independent configuration, resolving 640 and applying the machine-dependent variables, and releasing 650 the environment.

In certain embodiments, the objects deployed in step 620 may be binaries or ASCII-based files. In step 640, the machine-dependent variables or characteristics may include the IP address of the machine, a listening port, a file system format, a user account, or other machine-dependent variable or characteristic known to those in the art. The holding 610 the environment step may correspond to the first step of a two phase commit process, or in the case of an SQL database, a transaction. In the latter case, the step of releasing 650 the environment may correspond to a commit.

Another embodiment of the present invention includes a method for maintaining a production computer system 340, and in particular for automating the deployment of a new component from a QA system 310 to a production system 340. The method may use application-specific plugins 323, 328, 317 to detect the changes 365 that occurred in the QA system during the installation of the new component, and to generate commands and change objects 375 used to replicate the changes in the production system.

The invention may take the form of an entirely hardware embodiment, an entirely software embodiment, or an embodiment containing both hardware and software elements. In one embodiment, the invention is implemented in software, which includes but is not limited to firmware, resident software, microcode, and the like.

Furthermore, the invention may take the form of a computer program product accessible from a computer-usable or computer-readable medium providing program code for use by or in connection with a computer or any instruction execution system. For the purposes of this description, a computer-usable or computer readable medium may be any apparatus that can contain, store, communicate, propagate, or transport the program for use by or in connection with the instruction execution system, apparatus, or device.

The medium may include an electronic, magnetic, optical, electromagnetic, infrared, or semiconductor system (or apparatus or device) or a propagation medium. Examples of a computer-readable medium may include a semiconductor or solid state memory, magnetic tape, a removable computer diskette, a random access memory (RAM), a read-only memory (ROM), a rigid magnetic disk and an optical disk. Current examples of optical disks may include compact disk-read only memory (CD-ROM), compact disk-read/write (CD-R/W) and DVD.

A data processing system suitable for storing and/or executing program code may include at least one processor coupled directly or indirectly to memory elements through a system bus. The memory elements may include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

1. A method for deploying a component onto a production computer system, the method comprising:
identifying at least one alteration associated with deployment of a first application onto a first computer system, wherein the first application on the first computer system is substantially similar to a second application on a second computer system;
generating a command and an object corresponding to the alteration, the command and the object being generated as a function of the first application; and
replicating the alteration on the second application of the second computer system by executing the command and the object on the second computer system.

2. The method of claim 1, wherein the alteration comprises at least one of an application data alteration and an application configuration alteration.

3. The method of claim 1, wherein the object corresponding to the alteration is selected from the group consisting of a binary file, an ASCII-based file, a machine-independent characteristic, and a machine-dependent characteristic.

4. The method of claim 3, wherein executing the command and the object on the second computer system further comprises:
maintaining a current state of the second computer system;
deploying at least one of the binary file and the ASCII-based file on the second computer system;
applying the machine-independent characteristic on the second computer system;
adapting the machine-dependent characteristic to the second computer system; and
applying the machine-dependent characteristic on the second computer system.

5. The method of claim 1, wherein the command is selected from the group consisting of a create operation, a retrieve operation, an update operation, and a delete operation.

6. The method of claim 1, wherein identifying the at least one alteration further comprises:
commencing at least one of installation and configuration of the first application onto the first computer system;
registering a first state of the first application;
completing the at least one of the installation and configuration;
registering a second state of the first application;
analyzing the first and the second states; and
identifying at least one alteration between the first and the second states.

7. The method of claim 1, wherein the first computer system is a quality assurance system, and wherein the second computer system is a production system.

8. An apparatus for deploying a component onto a production computer system, the apparatus comprising:
a change analyzer for identifying at least one alteration associated with deployment of a first application onto a first computer system, wherein the first application on the first computer system is substantially similar to a second application on a second computer system;
a change description generator for generating a command and an object corresponding to the alteration, the command and the object being generated as a function of the first application; and
a change replication system for replicating the alteration on the second application of the second computer system by executing the command and the object on the second computer system.

9. The apparatus of claim 8, wherein the alteration comprises at least one of an application data alteration and an application configuration alteration.

10. The apparatus of claim 8, wherein the object corresponding to the alteration is selected from the group consisting of a binary file, an ASCII-based file, a machine-independent characteristic, and a machine-dependent characteristic.

11. The apparatus of claim 8, wherein the command is selected from the group consisting of a create operation, a retrieve operation, an update operation, and a delete operation.

12. The apparatus of claim 8, wherein the change analyzer further comprises:
a state analyzer for registering a first state and a second state of the first application, wherein the first state is registered upon commencing at least one of installation and configuration of the first application onto the first computer system, and wherein the second state is registered upon completing the at least one of installation and configuration; and
a state difference generator for analyzing the first and the second states and identifying at least one alteration therebetween.

13. The apparatus of claim 8, wherein the first computer system is a quality assurance system, and wherein the second computer system is a production system.

14. A computer program product for deploying a component onto a production computer system, the computer program product comprising:
a computer-usable medium having computer-usable program code embodied therein, the computer-usable program code comprising:
computer-usable program code for identifying at least one alteration associated with deployment of a first application onto a first computer system, wherein the first application on the first computer system is substantially similar to a second application on a second computer system;
computer-usable program code for generating a command and an object corresponding to the alteration, the command and the object being generated as a function of the first application; and
computer-usable program code for replicating the alteration on the second application of the second computer system by executing the command and the object on the second computer system.

15. The computer program product of claim 14, wherein the alteration comprises at least one of an application data alteration and an application configuration alteration.

16. The computer program product of claim 14, wherein the object corresponding to the alteration is selected from the group consisting of a binary file, an ASCII-based file, a machine-independent characteristic, and a machine-dependent characteristic.

17. The computer program product of claim 14, wherein the computer-usable program code for replicating the alteration on the second application further comprises:
computer-usable program code for maintaining a current state of the second computer system;
computer-usable program code for deploying at least one of a binary file and an ASCII-based file on the second computer system;
computer-usable program code for applying a machine-independent characteristic on the second computer system;
computer-usable program code for adapting a machine-dependent characteristic to the second computer system; and
computer-usable program code for applying the machine-dependent characteristic on the second computer system.

18. The computer program product of claim 14, wherein the command is selected from the group consisting of a create operation, a retrieve operation, an update operation, and a delete operation.

19. The computer program product of claim 14, wherein the computer-usable program code for identifying the at least one alteration further comprises:
computer-usable program code for commencing at least one of installation and configuration of the first application onto the first computer system;
computer-usable program code for registering a first state of the first application;
computer-usable program code for completing the at least one of installation and configuration;
computer-usable program code for registering a second state of the first application;
computer-usable program code for analyzing the first and the second states; and
computer-usable program code for identifying at least one alteration between the first and the second states.

20. The computer program product of claim 14, wherein the first computer system is a quality assurance system, and wherein the second computer system is a production system.
